(19) United States
(12) Patent Application Publication
(10) Pub. No.: US 2014/0089963 A1
(43) Pub. Date: Mar. 27, 2014

(54) METHOD OF MANAGING MULTIPLE CONTENT SERVERS

(71) Applicant: HANWHA SOLUTION & CONSULTING CO., LTD, Seoul (KR)

(72) Inventors: Tae Suk OH, Seoul (KR); Heung Soo PARK, Namyangju-si (KR)

(73) Assignee: HANWHA SOLUTION & CONSULTING CO., LTD, Seoul (KR)

(21) Appl. No.: 13/660,564

(22) Filed: Oct. 25, 2012

(30) Foreign Application Priority Data
Sep. 27, 2012 (KR) 10-2012-0107896

(51) Int. Cl. H04N 21/4367

(52) U.S. Cl. 725/30

(57) ABSTRACT

A method of managing multiple content servers to provide a portal service is provided. Personal information on a user managed by the portal service is mutually used by a plurality of content servers to authenticate or identify the user. The content servers use an ID of a set-top box and an integrated ID of the user transmitted from the set-top box so as to identify a particular user and a set-top box of the user among users provided with a plurality of services.

### CROSS-REFERENCE TO RELATED APPLICATION

This application claims the priority benefit of Korean Patent Application No. 10-2012-0107896, filed on Sep. 27, 2012, in the Korean Intellectual Property Office, the disclosure of which is incorporated herein by reference.

### BACKGROUND

1. Field of the Invention

The present invention relates to a method of managing servers providing contents, and more particularly, to a method of managing multiple content servers for providing a portal service.

2. Description of the Related Art

An open service may be configured using a set-top box and a smart television (TV). In the open service, various content providers (CPs) and service providers (SPs) may provide services through a home portal of an open service.

To provide an open service, the CPs and the SPs may need to manage and use databases (DBs) of users of an open service separately. Since the CPs and the SPs independently manage information on the users, a user should repeatedly provide their information to the CPs or SPs through a login process whenever the user changes or alternates between services. Such a repeated providing process causes an inconvenience for the user.

Further, a user may not want to provide their personal information to an unreliable CP or SP, which may hinder participation of a new CP or SP in an open service.

In addition, there is a risk of user information managed by a particular CP or SP being leaked by malicious hacking or unforeseeable circumstances. The leaked personal information may be misused for a service of the CP or SP. Moreover, the leaked user information may also be misused for other services in which the same identifier (ID) and the same password for authentication of the user are used.

### SUMMARY

An aspect of the present invention provides a method of managing a plurality of content servers providing a service in an open service based on a smart TV or a smart set-top box.

Another aspect of the present invention also provides a method of managing a plurality of content servers providing a portal service by transmitting integrated personal information on a user of a set-top box.

According to an aspect of the present invention, there is provided a method of managing multiple content servers to provide a portal service, which manages a plurality of content servers for a server to provide a portal service, the method including registering a user and a set-top box associated with each other by storing an identifier (ID) of the set-top box and personal information on the user of the set-top box to be associated, receiving an integrated ID input value and an integrated password input value from the set-top box, authenticating the user by comparing the integrated ID input value with an integrated ID of the user registered as the personal information and comparing the integrated password input value with an integrated password of the user registered as the personal information, and transmitting a plurality of links with respect to a plurality of services provided by the respective contents servers to the set-top box, wherein the content servers are managed by different content providers, respectively, the integrated ID is used by all of the content servers to identify the user, each of the plurality of links comprises information on the ID of the set-top box and the integrated ID of the user, the ID of the set-top box and the integrated ID of the user are provided to a first content server by transmitting a first link associated with a first service among the links from the set-top box to the first content server providing the first service so as to access the first service among the plurality of services, and the ID of the set-top box and the integrated ID of the user are used by the first content server to authenticate the set-top box and the user.

The registering may include transmitting a uniform resource locator (URL) of a registration web page for registering the personal information on the user to the set-top box, receiving a request for the registration web page from a terminal of the user, transmitting the registration web page to the terminal, receiving the ID of the set-top box and a password of the set-top box from the terminal, receiving the personal information from the terminal, and storing the personal information and the ID of the set-top box associated with each other.

The method may further include transmitting information needed to provide the first service among the personal information to the first content server.

The method may further include adding a new service to the plurality of services.

The adding may include transmitting an identification request for integrated management of the new service to the set-top box, receiving an identification response to the integrated management from the set-top box, and transmitting the ID of the set-top box and the integrated ID of the user among the personal information to the new service.

The ID of the set-top box and the integrated ID of the user may be provided to a second content server by transmitting a second link associated with a second service to which the user is a non-subscriber among the plurality of links from the set-top box to the second content server so as to access the second service among the services.

The ID of the set-top box and the integrated ID of the user may be used by the second content server to authenticate the set-top box and the user.

The first service may be a service with respect to a first closed user group (CUG).

The second service may be a service with respect to a second CUG.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating a method of providing a portal service according to an exemplary embodiment of the present invention;

FIG. 2 is a flowchart illustrating an initial registration process according to an exemplary embodiment of the present invention;

FIG. 3 is a flowchart illustrating a login process according to an exemplary embodiment of the present invention;

FIG. 4 is a flowchart illustrating a service providing process according to an exemplary embodiment of the present invention;

FIG. 5 is a flowchart illustrating a service adding process according to an exemplary embodiment of the present invention;

FIG. 6 is a diagram illustrating a configuration of a portal service using integrated personal information according to an exemplary embodiment of the present invention;

FIG. 7 illustrates a database (DB) table of a portal server according to an exemplary embodiment of the present invention;

FIG. 8 illustrates a structure of a link according to an exemplary embodiment of the present invention; and

FIG. 9 illustrates an enhanced closed user group (CUG) service according to an exemplary embodiment of the present invention.

### DETAILED DESCRIPTION

Hereinafter, exemplary embodiments of the present invention will be described in detail with reference to the accompanying drawings, wherein like reference numerals refer to the like elements throughout.

In the following description, the terms “uniform resource locator (URL)” and “uniform resource identifier (URI)” denote the same meaning and may be replaced by each other.

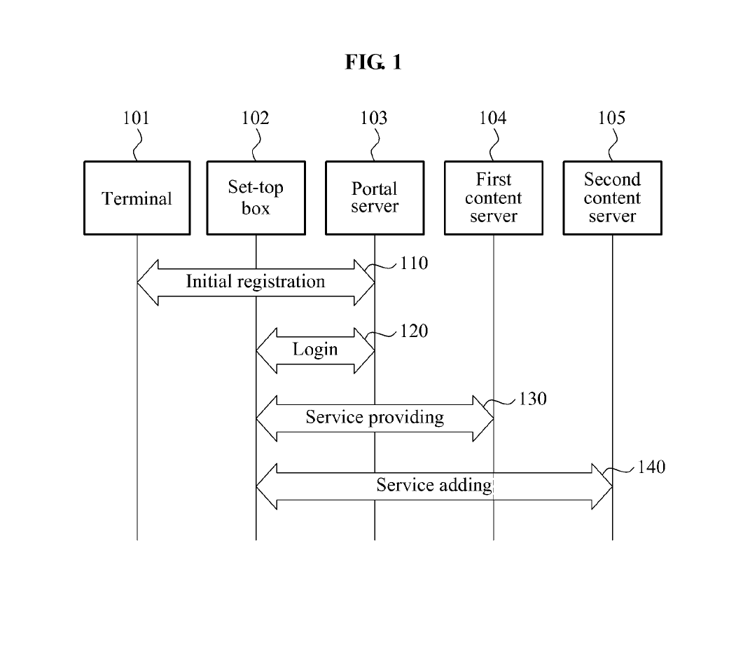

FIG. 1 is a signal flowchart illustrating a method of providing a portal service according to an exemplary embodiment of the present invention.

Generally, considering that an Internet Protocol television (IPTV) service is provided to home users, a portal service may refer to a home portal service.

In the portal service to be described below, a portal server 103 may manage a plurality of content servers to provide a portal service.

The content servers may provide a service to a user of each portal service. Here, the expression “providing a service” may mean that a content server transmits content to a set-top box 102 of a user. The set-top box 102 may output the transmitted content. Further, the service may refer to an IPTV service provided by a content provider (CP) or service provider (SP). The portal service may be a service providing portals of services provided by a plurality of CPs and SPs.

The content may include media content, such as music and a video, and information in a document form, such as a webpage. Further, the content may be multimedia content, for example, a webpage including media content, such as an image and a video.

A plurality of services provided by the contents servers may be provided by different CPs or SPs, respectively. That is, the content servers may be managed by different content providers, respectively.

While the services are managed by different agents, pieces of personal information on a user used to access the services may be integrated. For example, the pieces of the integrated personal information may include an integrated ID and an integrated password of the user. That is, the personal information on the user managed by the portal service may be used for all of the content services to authenticate or identify the user. The services may be provided limitedly to particular users.

For example, the integrated ID of the user may be used by all of the content servers to identify the user. The content servers may use an ID of the set-top box 102 and the integrated ID of the user transmitted from the set-top box 102 to identify a particular user among users provided with the services, and the set-top box 102 of the user.

The services may need detailed personal information. For example, a service provided on a limited basis to a particular subject may request a resident registration number of a user as personal information for the particular service in order to objectively determine an age of the user. The personal information for the particular service may include an ID for the particular service and a password for the particular service.

A terminal 101 may be another device used by the user of the set-top box 102. For example, the terminal 101 may include a personal computer (PC) or a smartphone.

The terminal 101 may include a web browser, and provide a general Internet service to a user by accessing a server using a URL. The terminal 101 may be used for initial registration of a user, as will be described later.

The set-top box 102 may provide a portal service to the user of the set-top box 102. The set-top box 102 may be a smart set-top box or a smart TV.

The portal server 103 may provide a portal service to the set-top box 102.

A first content server 104 may be a content server providing a first service among the content servers. The first content server 104 may provide contents associated with the first service.

A second content server 105 may be a content server providing a second service among the content servers. The second content server 105 may provide contents associated with the second service.

In an initial registration process 110, the user of the set-top box 102 may be registered in the portal server 103 by the terminal 101, the set-top box 102, and the portal server 103.

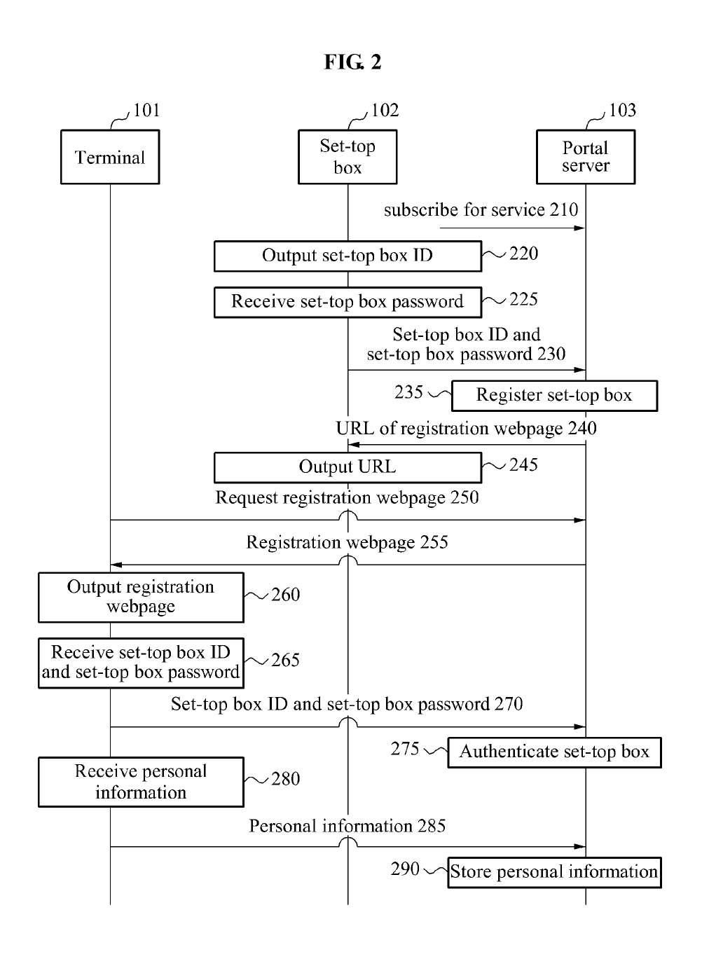

In the initial registration process 110, the portal server 103 may store the ID of the set-top box 102 and the personal information on the user of the set-top box 102 associated with each other, thereby registering the user in association with the set-top box 102. The initial registration process 110 will be described below with reference to FIG. 2.

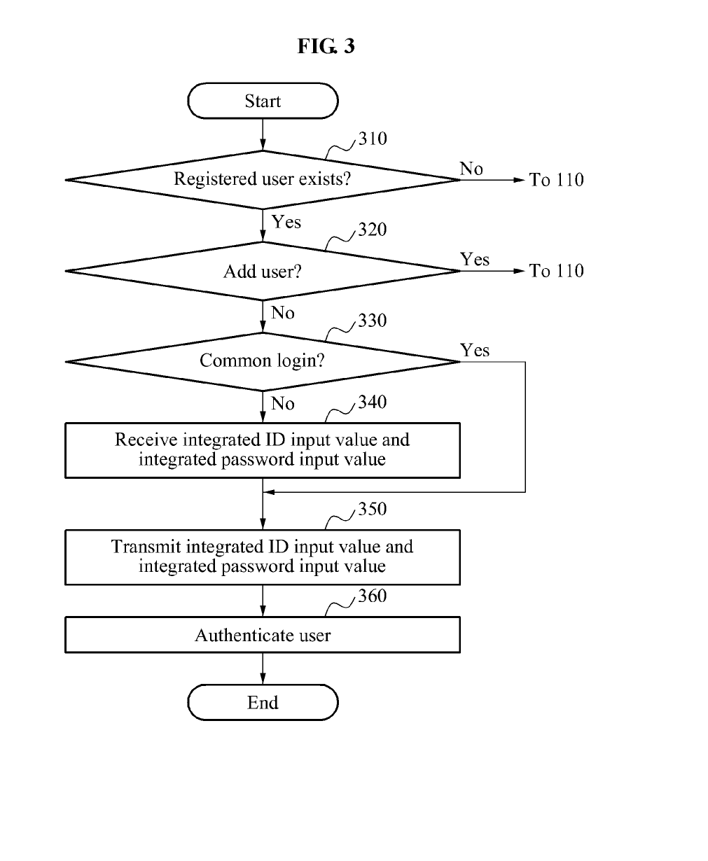

In a login process 120, the portal server 103 may authenticate the user based on an input value transmitted from the set-top box 102. The login process 120 will be described below, with reference to FIG. 3.

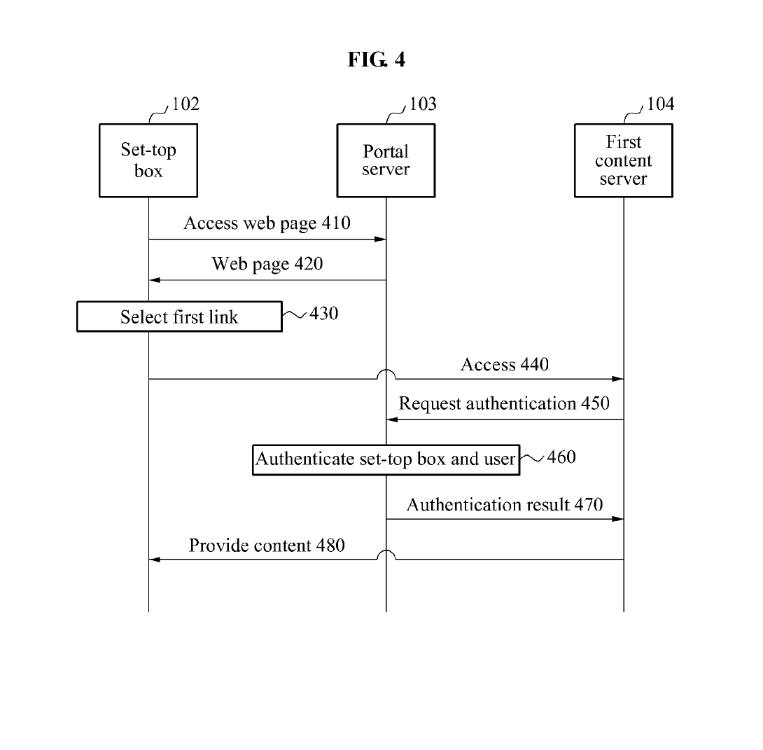

In a service providing process 130, a service may be provided from a plurality of content servers including the first content server 104 among the content servers. The service providing process 130 will be described below with reference to FIG. 4.

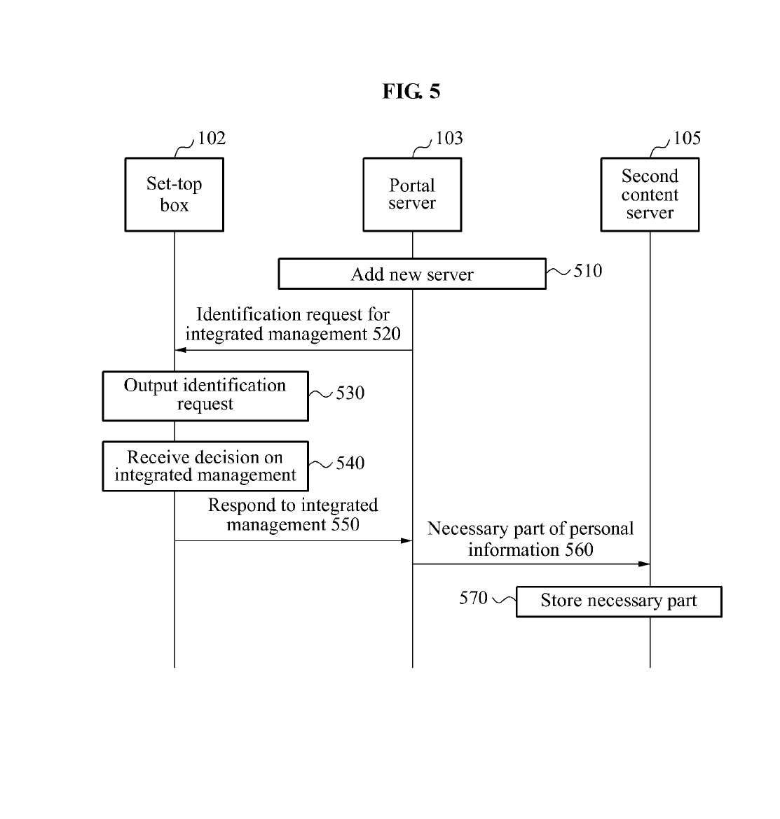

In a service adding process 140, a new service provided by the second content server 105 may be added to the services. The service adding process 140 will be described below with reference to FIG. 5.

FIG. 2 is a flowchart illustrating the initial registration process according to an exemplary embodiment of the present invention.

The initial registration process 110 may include operations 210 to 290 as follows.

In operation 210, the portal service 103 may receive a subscription for a service. The subscription for the service may include an agreement to terms and conditions for use of a portal service provided by the portal server 103.

The subscription for the service may include personal information on a user. The personal information may include an integrated ID and an integrated password of the user. Further, the personal information may include personal information for a particular service needed to provide the particular service among the respective services. The personal information for the particular service may include an ID and a password for the particular service.

For example, the user may subscribe to a service by submitting an off-line application, and the subscription for the service may be transmitted to the portal server 103 by a service subscription administrator of the portal service. Alternatively, the subscription for the service may be input by a user or a service subscription administrator. In addition, the subscription for the service may be transmitted from the terminal 101 or the set-top box 102 to the portal server 103.

In operation 220, when the set-top box 102 is turned on by the user initially, the set-top box 102 may output an ID of the set-top box 102.

In operation 225, the user may input a password of the set-top box 102 to the set-top box 102. The set-top box 102 may receive the password of the set-top box 102 input by the user.

In operation 230, the set-top box 102 may transmit the ID and the password of the set-top box 102 to the portal server 103. The portal server 103 may receive the ID and the password of the set-top box 102 from the set-top box 102.

In operation 235, the portal server 103 may register the set-top box 102 using the ID and the password of the set-top box 102. The portal server 103 may store the ID and the password of the set-top box 102 in a database (DB) of the portal server 103.

In operation 240, the portal server 103 may transmit a URL of a registration web page for registering the personal information in on the user to the set-top box 102. The set-top box 102 may receive the URL from the portal server 103. As the personal information on the user may be registered in the web page indicated by the URL, the URL may be named an online subscription URL.

In operation 245, the set-top box 102 may output the received URL. The user may recognize an address of the web page for registering the personal information on the user through the output URL. Then, the terminal 101 of the user may access the web page using the received URL.

In operation 250, the terminal 101 may transmit a request for the web page to the portal server 103. The portal server 103 may receive the request for the web page transmitted from the terminal 101.

In operation 255, the portal server 103 may transmit the requested web page to the terminal 101. The terminal 101 may receive the web page from the portal server 103.

In operation 260, the terminal 101 may output the received web page.

In operation 265, the user may input the ID and the password of the set-top box 102 in input items of the output web page. The terminal 101 may receive the ID and the password of the set-top box 102 input by the user through the input items of the web page.

In operation 270, the terminal 101 may transmit the ID and the password of the set-top box 102 to the portal server 103. The portal server 103 may receive the ID and the password of the set-top box 102 from the terminal 101.

In operation 275, the portal server 103 may authenticate the set-top box 102 by comparing the received ID and password of the set-top box 102 with the ID and password of the set-top box 102 stored in the portal server 103. Here, authenticating the set-top box 102 may refer to identifying the personal information transmitted from the terminal 101 as the personal information on the user input by the user of the set-top box 102.

When the set-top box 102 is authenticated, the following operations may be performed. When the terminal 101 fails to be authenticated, a previous operation, for example, operation 260, may be repeated. When operation 260 is repeated, the set-top box 102 may output a message indicating that the ID or password of the set-top box 102 is incorrect.

In operation 280, the user may input the personal information on the user in the input items of the output web page. The terminal 101 may receive the personal information on the user input by the user through the input items of the web page. Here, the personal information on the user may include an integrated ID of the user, an integrated password of the user, and personal information for a particular service.

In operation 285, the set-top box 102 may transmit the personal information on the user to the portal server 103. The portal server 103 may receive the personal information on the user from the set-top box 102.

In operation 290, the portal server 103 may store the received personal information to be associated with the ID of the set-top box 102.

According to the foregoing operations 210 and 290, the personal information on the user may be stored in the portal server 103 in association with the ID of the set-top box 102 when a subscription for a service is received or the set-top box 102 is installed. The DB of the portal server 103 may store a user ID, a user password, and user personal information for a particular service.

FIG. 3 is a flowchart illustrating the login process according to an exemplary embodiment of the present invention.

The login process 120 may include operations 310 to 360 as follows.

In operation 310, the set-top box 102 may determine whether there is a registered user. In order to determine whether there is a registered user, the set-top box 102 may place an inquiry with the portal server 103 to determine whether a registered user associated with the set-top box 102 is present, while transmitting information, such as the ID of the set-top box 102 to the portal server 103. The set-top box 102 may receive a response to the inquiry from the portal server 103.

When a registered user is absent, the initial registration process 110 described above with reference to FIG. 1 may be carried out.

In operation 320, it may be determined whether a user is to be added. When the user of the set-top box 102 is a new user, the user may be added as the user of the set-top box 102. To add a new user, the initial registration process 110 with respect to the user to be added may be performed.

When the new user is added, existing users and the newly added user may log on to the portal server 103 using their own integrated IDs and integrated passwords and be provided with a portal service from the portal server 103.

In operation 330, a common login may be selected. The common login may refer to using a portal service with a common ID and common password of the set-top box 102. For example, the common login may be utilized so that a service for which registration is not required may be used. When the common login is selected, operation 340 may be omitted, and the common ID and common password may be used as an integrated ID input value and integrated password input value, respectively, in operation 350, which will be described.

In operation 340, the user may input their own integrated ID input value and integrated password input value in the set-top box 102. The set-top box 102 may receive the integrated ID input value and integrated password input value input by the user. When the integrated ID input value and integrated password input value of the user are already stored in the set-top box 102, operation 340 may be omitted.

In operation 350, the set-top box 102 may transmit the integrated ID input value and integrated password input value to the portal server 103. The portal server 103 may receive the integrated ID input value and integrated password input value from the set-top box 103.

In operation 360, the portal server 103 may authenticate the user by comparing the received integrated ID input value with the integrated ID of the user registered as the personal information on the user, and the received integrated password input value with the integrated password of the user registered as the personal information on the user.

When the user is authenticated, the set-top box 102 may be provided with a portal service from the portal server 103. Further, the set-top box 102 may be provided with content services from the plurality of content servers through the portal server 103.

FIG. 4 is a flowchart illustrating the service providing process according to an exemplary embodiment of the present invention.

The service providing process 130 may include operations 410 to 480 as follows. In operation 410, the set-top box 102 may access a portal service web page providing a portal service. The set-top box 102 may request the portal service web page from the portal server 103. The portal server 103 may receive the request for the portal service web page from the set-top box 102.

In operation 420, the portal server 103 may transmit the portal service web page in response to the request for the portal service web page.

The portal service web page may include a plurality of links. The links may be links with respect to a plurality of services provided by the respective contents servers. Thus, the portal server 103 may transmit the plurality of links with respect to the plurality of services provided by the respective content servers in response to the request for the portal service web page.

Each of the links may include information on the ID of the set-top box 102 and information on the integrated ID of the user.

In operation 430, the user of the set-top box 102 may select a first service among the services. The user of the set-top box 102 may select a first link associated with the first service among the links so as to access the first service among the services. The set-top box 102 may receive user input of selecting the first link. When the first link indicates a first content server 104 providing the first service among the content servers, the first link and the first service may be associated with each other. The first service may mean the first content server 104 provides content.

In operation 440, the set-top box 102 may access the first content server 104 using the first link. Such access may enable the first link to be transmitted from the set-top box 102 to the first content server 104.

The first content server 104 may identify the content requested by the set-top box 102 using the transmitted first link.

Further, the first content server 104 may authenticate the set-top box 102 and the user using the transmitted first link. The first link may include the ID of the set-top box 102 and the integrated ID of the user. That is, the first link is transmitted from the set-top box 102 to the first content server 104 to access the first service among the services, thereby providing the ID of the set-top box 102 and the integrated ID of the user to the first content server 104. The ID of the set-top box 102 and the integrated ID of the user may be used by the first content server 104 to authenticate the set-top box 102 and the user.

In operation 450, the first content server 104 may transmit a request for authentication of the set-top box 102 and the user to the portal server 103. The first content server 104 may transmit the ID of the set-top box 102 and the integrated ID of the user, which are transmitted through the link, along with the request.

In operation 460, the portal server 103 may authenticate the set-top box 102 and the user by comparing the ID of the set-top box 102 transmitted from the first content server 104 with the ID of the set-top box 102 stored in the portal server 103, and the integrated ID of the user transmitted from the first content server 104 with the integrated ID of the user stored in the portal server 103.

In operation 470, the portal server 103 may transmit an authentication result to the first content server 104 in response to the request for authentication. The first content server 104 may receive the authentication result from the portal server 103.

The portal sever 103 may transmit information needed to provide the first service among the personal information on the user stored in the portal server 103, along with the authentication result, to the first content server 104. Alternatively, the portal server 103 may transmit the information needed to provide the first service among the personal information on the user stored in the portal server 103 to the first content server 104, separately from the authentication result. Here, the information needed to provide the first service may be the personal information for the particular service described above with reference to FIG. 1 or personal information for the first service.

In operation 480, the first content server 104 may provide the requested content to the set-top box 102. The requested content may be content indicated by the link transmitted to the first content server 104.

FIG. 5 is a flowchart illustrating the service adding process according to an exemplary embodiment of the present invention.

The service adding process 140 may include operations 510 to 570 as follows.

In operation 510, the portal server 103 may add a new server providing a new service, that is, the second content server 105, to the content servers.

In operation 520, the portal server 103 may transmit an identification request for integrated management of the new service to the set-top box 102. The set-top box 102 may receive the identification request for the integrated management of the new service from the portal server 103.

The integrated management may refer to the personal information on the user is used with respect to a second content server 105 providing the new service. The personal information may include an integrated ID and an integrated password.

In operation 530, the set-top box 102 may output the identification request for the integrated management of the new service using a pop-up mode or the like.

The set-top box 102 may output terms and conditions for the integrated management of the new service and changed terms and conditions for the portal service after the new service is added to the integrated management.

In operation 540, the user may make a decision on agreement to the integrated management of the new service and the terms and conditions and input the decision to the set-top box 102. The set-top box 102 may receive the decision on the integrated management of the new service input by the user. The decision may include a confirmation response indicating agreement to the integrated management of the new service and the terms and conditions and a rejection response indicating disagreement as to the integrated management of the new service and the terms and conditions.

In operation 550, the set-top box 102 may transmit the confirmation response or rejection response as to the integrated management of the new service to the portal server 103. The portal server 103 may receive the confirmation response or rejection response as to the integrated management of the new service from the set-top box 102.

In operation 560, when the received response is the confirmation response, the set-top box 102 may transmit a necessary part to provide the second service among the personal information on the user to the second content server 105. The second content server 105 may receive the necessary part to provide the second service from the set-top box 102. Here, the necessary part may include the integrated ID of the user and the integrated password of the user.

In operation 570, the second content server 105 may store the received necessary part in the second content server 105.

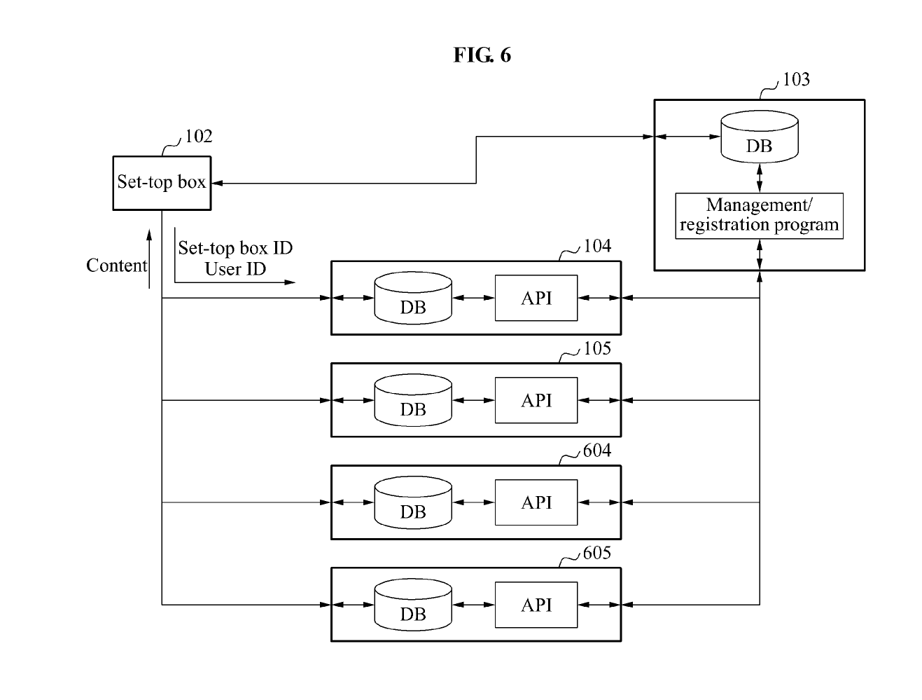

FIG. 6 is a diagram illustrating a configuration of a portal service using integrated personal information according to an exemplary embodiment of the present invention.

FIG. 6 illustrates a set-top box 102, a portal server 103, and a plurality of content servers. The content servers may include a first content server 104, a second content server 105, a third content server 604, and a fourth content server 605.

Each of the content servers may include a DB. Each DB may store personal information for a particular service provided by the content server.

Each content server may include an application programming interface (API) to request the personal information for the particular service to be stored in the DB. For example, input or output of the personal information for the particular service may be achieved through the API. The respective content servers may provide different APIs in accordance with platforms or operating systems of the content servers.

The portal server 103 may include a DB. The DB may store personal information on each individual user of the portal service. Here, the personal information may include personal information for a particular service. The portal server 103 may operate a management/registration program to provide the personal information to the content servers. The personal information for the particular service provided through the management/registration program may be stored in a DB of a content server via an API of a content server providing the particular service.

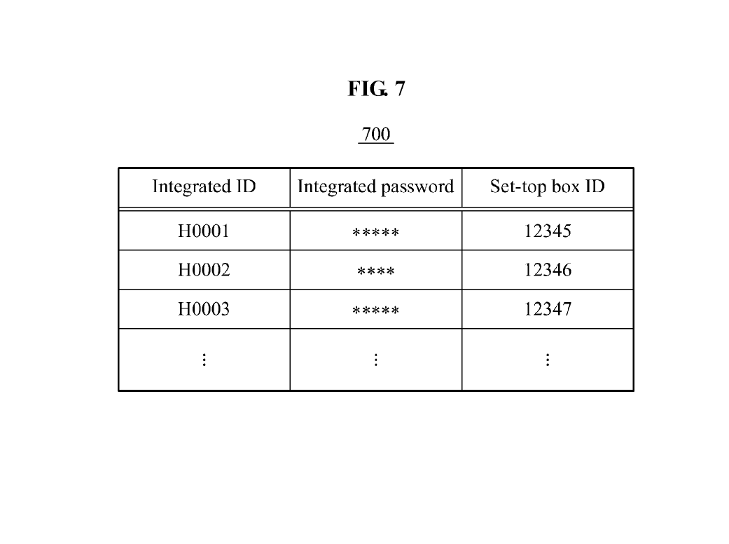

FIG. 7 is a diagram illustrating a DB table of a portal server according to an exemplary embodiment of the present invention.

The table 700 may be a master table of the DB.

Each row of the table illustrates an integrated ID of each user, an integrated password of the user, and an ID of a set-top box 102 of the user.

Each column illustrates personal information on a particular user.

A portal server 103 may provide integrated personal information for use of a portal service and services of a plurality of content servers through the table.

The integrated passwords may be encoded and stored.

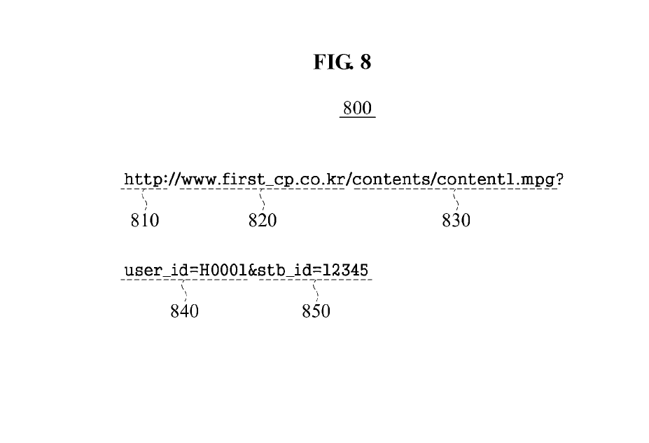

FIG. 8 is a diagram illustrating a structure of a link according to an exemplary embodiment of the present invention.

The link 800 may include a protocol name 810, a content server address 820, a content address 830, a first argument 840, and a second argument 850.

The protocol name 810 represents a protocol for accessing a content server. In FIG. 8, a hypertext transfer protocol (HTTP) is used to access the content server. That is, the link 800 may be a URL of the HTTP protocol.

The content server address 820 represents an address of the content server. The content server address 820 may represent an internet protocol (IP) address of the content server to which the link is transmitted and represent a domain name corresponding to the IP address.

The content address 830 may represent requested content. The content server may specify the requested content using the content address 830.

The first argument 840 and the second argument 850 may be used to transmit a parameter to each content server. The first argument 840 and the second argument 850 may represent a parameter name and a parameter value, respectively. Here, the parameter may be a user ID or a set-top box 102 ID. In FIG. 8, the first argument 840 is a user ID of “testuser” and the second argument 850 is a set-top box 102 ID of “stb0001”.

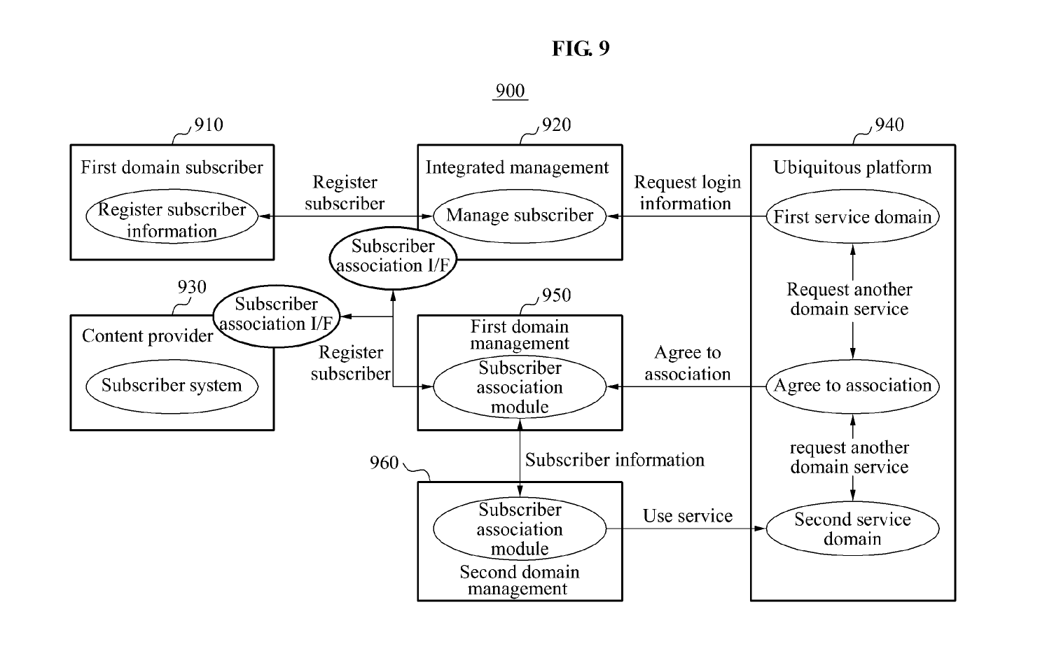

FIG. 9 is a diagram illustrating an enhanced closed user group (CUG) service according to an exemplary embodiment of the present invention.

The foregoing embodiments may relate to a method of providing an integrated service to integrate a plurality of CPs and SPs included in a single CUG. Furthermore, the foregoing embodiments may also provide a method of integrating a plurality of CUG services when there are the plurality of CUG services. A portal server 103 may provide integrated personal information to the CUG services.

For example, providing integrated personal information on a user will be described below when the first service is a service with respect to a first CUG, a second service is a service with respect to a second CUG, and the user subscribes only to the first CUG.

In operation 440 of FIG. 4, a second link may be used to access a second service to which the user does not subscribe among the plurality of services. The second link may be a link associated with the second service among the plurality of links.

In operation 450, when the second link is transmitted from the set-top box 102 to the second content server 105, thereby providing the ID of the set-top box 102 and the integrated ID of the user to the second content server 105.

In operations 450 and 460, the ID of the set-top box 102 and the integrated ID of the user may be used by the second content server 105 to authenticate the set-top box 102 and the user.

An enhanced CUG service system 900 may include a first domain subscriber 910, integrated management 920, a content provider 930, a ubiquitous platform 940, first domain management 950, and second domain management 960. A first domain and a second domain may represent a plurality of CUGs.

The first domain subscriber 910 may correspond to the user of the set-top box 102 described above with reference to FIGS. 1 to 8. The user may subscribe to the first domain.

The integrated management 920 and the ubiquitous platform 940 may correspond to the portal server 103 described above with reference to FIGS. 1 to 8.

The first domain management 950 and the second domain management 960 may correspond to part of the content servers described above with reference to FIGS. 1 to 8.

The first domain subscriber 910 may perform subscriber registration with respect to the ubiquitous platform 940. The first domain subscriber 910 may register subscriber information for subscriber registration.

The integrated management 920 may manage a subscriber.

Each CUG may provide a subscriber registration interface and register a subscriber. For example, an administrator of each CUG may register information on a user of the CUG in a server providing a CUG service using user registration programs.

The content provider 930 providing content to the first domain may include a subscriber system.

The integrated management 920 and the content provider 930 may provide subscriber associated interfaces, respectively. The first domain management 950 may register a subscriber registered in the integrated management 920 through the subscriber associated interfaces of the integrated management 920 and the content provider 930. For example, personal information on a CUG user may be transmitted to the first domain management 960 and the content provider 930. The first domain subscriber may be registered as a member of a first CUG service indicated by the content provider 930 and the first domain management by the subscriber associated interfaces.

The ubiquitous platform 940 may provide an association between CUGs. Here, an association may refer to a subscriber to a first CUG being registered as a subscriber to another CUG. In this instance, the other CUG may be a second CUG.

The first domain subscriber 910 may log in through the integrated management 920. The ubiquitous platform 940 may request information on login of the first domain subscriber 910 from the integrated management 920.

The first domain subscriber 910 may request another domain service which the subscriber is not registered in, and the ubiquitous platform 940 may process the request for the other domain service. To process the request, an agreement to associate a first service domain and a second service domain is required. That is, when the first domain subscriber 910 is not registered as a subscriber to the second service domain, a subscriber registration agreement procedure may be carried out. After acquiring a subscriber registration agreement, the second domain management 960 may request subscriber information from the first domain management 950. The first domain management 950 may transmit the subscriber information to the second domain management 960. When the subscriber information is transmitted, the second domain management 960 may perform the subscriber registration.

Through the foregoing process, the first domain management 950 may use a service of the second service domain in a login status.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

As described above, integrated personal information on a user of a set-top box is provided to a plurality of content servers, thereby providing the user with convenience in subscribing to services provided by the respective content servers and changing between the services.

Integrated personal information on a user of a set-top box is provided to a new content server, thereby inducing activation of new services and leading to participation of various CPs and SPs.

A variety of CPs and SPs may participate in an open service. The participant CPs and SPs may be provided with integrated personal information, thereby enabling association between services provided by the CPs and SPs. Accordingly, a user may easily access various services without subscribing to each service and login.

Although a few exemplary embodiments of the present invention have been shown and described with reference to the accompanying drawings, various alterations and modifications may be made by those having ordinary skill in the art without departing from the spirit and scope of the invention. For example, the methods or processes described above may be carried out in different order, and/or the aforementioned elements, such as systems, structures, devices or circuits, may be coupled or combined in different forms or be replaced or substituted by other elements or equivalents thereof, while obtaining substantially the same result.

What is claimed is:

1. A method of managing multiple content servers to provide a portal service for managing a plurality of content servers of a portal server providing a portal service, the method comprising:
registering a user and a set-top box associated with each other through storing an identifier (ID) of the set-top box and personal information on the user of the set-top box to be associated with the user;
receiving an integrated ID input value and an integrated password input value from the set-top box;
authenticating the user by comparing the integrated ID input value with an integrated ID of the user registered as the personal information and comparing the integrated password input value with an integrated password of the user registered as the personal information; and
transmitting a plurality of links with respect to a plurality of services provided by the respective contents servers to the set-top box,
wherein the content servers are each managed by different content providers, respectively,
the integrated ID is used by all of the content servers to identify the user,
each of the plurality of links comprises information on the ID of the set-top box and the integrated ID of the user,
the ID of the set-top box and the integrated ID of the user are provided to a first content server by transmitting a first link associated with a first service among the plurality of links from the set-top box to the first content server providing the first service so as to access the first service among the plurality of services, and
the ID of the set-top box and the integrated ID of the user are used by the first content server to authenticate the set-top box and the user.

2. The method of claim 1, wherein the registering comprises:
transmitting a uniform resource locator (URL) for a registration web page for registering the personal information on the user to the set-top box;
receiving a request for the registration web page from a terminal of the user;
transmitting the registration web page to the terminal;
receiving the ID of the set-top box and a password of the set-top box from the terminal;
receiving the personal information from the terminal; and
storing the personal information and the ID of the set-top box associated with each other.

3. The method of claim 1, further comprising transmitting information needed to provide the first service among the personal information to the first content server.

4. The method of claim 1, further comprising:
adding a new service to the plurality of services,
wherein the adding comprises transmitting an identification request for integrated management of the new service to the set-top box;
receiving an identification response to the integrated management from the set-top box; and
transmitting the ID of the set-top box and the integrated ID of the user among the personal information to the new service.

5. The method of claim 1, wherein the ID of the set-top box and the integrated ID of the user are provided to a second content server by transmitting a second link associated with a second service to which the user is a non-subscriber among the links from the set-top box to the second content server so as to access the second service among the services,
the ID of the set-top box and the integrated ID of the user are used by the second content server to authenticate the set-top box and the user,
the first service is a service with respect to a first closed user group (CUG), and the second service is a service with respect to a second CUG.
